(19) United States
(12) Patent Application Publication
(10) Pub. No.: US 2011/0223347 A1
(43) Pub. Date: Sep. 15, 2011

(54) Presensitizing Films Using Time Delays

(75) Inventor: Deanna McMillen, Austin, TX (US)

(73) Assignee: ZEBRA IMAGING, INC., Austin, TX (US)

(21) Appl. No.: 12/720,682

(22) Filed: Mar. 10, 2010

(51) Int. Cl. B05D 3/06; G21K 5/00; B05C 9/10

(52) U.S. Cl. 427/532; 250/492.1; 118/620; 118/696

(57) ABSTRACT

Methods and systems for presensitizing film, including causing a presensitization effect on a region of a film, the presensitization effect, as a function of time, exhibiting a presensitization effect peak after a peak time from an initiation of the presensitization effect, and exposing, after a delay time, substantially the same region of the film to a spectrum of information-containing electromagnetic radiation, the presensitization effect at the delay time being substantially equal to the presensitization effect peak.

### RELATED APPLICATIONS INFORMATION

The subject matter of the present application is related to the subject matter of the following commonly assigned, co-pending applications:

U.S. Application entitled “Presensitizing Films Using a Pipeline Process” and naming Deanna McMillen, as inventor(s); and

U. S. Application entitled “Processing Films Using a Symmetric Head Assembly” and naming Deanna McMillen, as inventor(s).

The above-referenced patents and/or patent applications are hereby incorporated by reference herein in their entirety.

### BACKGROUND

The invention relates generally to the field of recording information in films.

### SUMMARY

In one respect, disclosed is a method for presensitizing film, the method comprising causing a presensitization effect on a region of a film, the presensitization effect, as a function of time, exhibiting a presensitization effect peak after a peak time from an initiation of the presensitization effect, and exposing, after a delay time, substantially the same region of the film to a spectrum of information-containing electromagnetic radiation, the presensitization effect at the delay time being substantially equal to the presensitization effect peak.

In another respect, disclosed is a system for presensitizing a film prior to recording information, the system comprising one or more processors, one or more memory units coupled to the one or more processors, one or more presensitizers coupled to the one or more processors and one or more recording electromagnetic sources coupled to the one or more processors, the system being configured to cause the one or more presensitizers to cause a presensitization effect on a region of the film, the presensitization effect, as a function of time, exhibiting a presensitization effect peak after a peak time from an initiation of the presensitization effect, and cause the one or more recording electromagnetic sources to expose, after a delay time, substantially the same region of the film to a spectrum of information-containing electromagnetic radiation, the presensitization effect at the delay time being substantially equal to the presensitization effect peak.

In yet another respect, disclosed is a computer program product embodied in a computer-operable medium, the computer program product comprising logic instructions, the logic instructions being effective to cause a presensitization effect on a region of a film, the presensitization effect, as a function of time, exhibiting a presensitization effect peak after a peak time from an initiation of the presensitization effect, and cause one or more recording electromagnetic sources to expose, after a delay time, substantially the same region of the film to a spectrum of information-containing electromagnetic radiation, the presensitization effect at the delay time being substantially equal to the presensitization effect peak.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a block diagram illustrating a system for presensitizing a film prior to recording information, in accordance with some embodiments.

FIG. 2 is a block diagram illustrating a system for presensitizing a film prior to recording information in which the presensitizing and recording scanning patterns are performed in a boustrophedotic fashion, in accordance with some embodiments.

FIG. 3 is a block diagram illustrating a head assembly for applying processes on regions of a film boustrophedoticly, in accordance with some embodiments.

FIG. 4 is a flow diagram illustrating a method for presensitizing a region of a film prior to recording information on the region of the film, such that the presensitization effect is maximized, in accordance with some embodiments.

FIG. 5 is a flow diagram illustrating a method for presensitizing additional regions of the film in a presensitizing scanning pattern and then recording on the additional regions of the film in a recording scanning pattern, in accordance with some embodiments.

FIG. 6 is a flow diagram illustrating a method for presensitizing additional regions of the film in a presensitizing scanning pattern while substantially simultaneously recording on previously presensitized regions of the film in a recording scanning pattern, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, a presensitization effect is caused on a region of the film, the presensitization effect, as a function of time, exhibiting a presensitization effect peak after a peak time from the initiation of the presensitization effect. After a delay time, substantially the same region of the film is exposed, to a spectrum of information-containing electromagnetic radiation, the presensitization effect at the delay time being substantially equal to the presensitization effect peak.

In some embodiments, the presensitization effect on the region of the film is caused by exposure to a spectrum of presensitizing electromagnetic radiation. In alternative embodiments, the presensitization effect on the region of the film is caused by exposure to one or more presensitizing chemicals. In yet other embodiments, the presensitization effect on the region of the film is caused by exposure to a presensitizing pattern of heat, by removing heat, or by applying moisture.

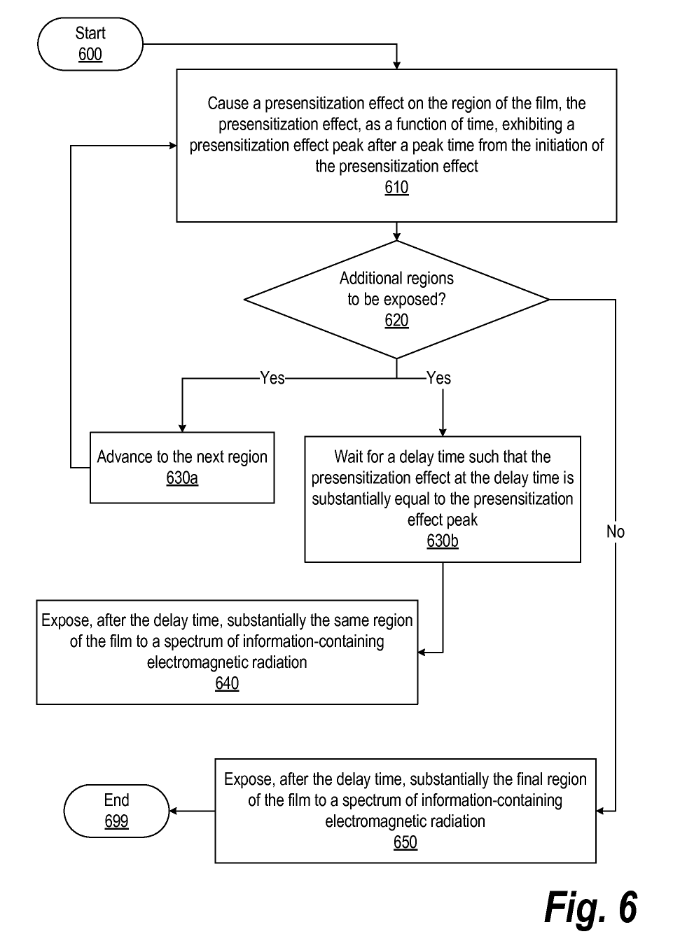

In alternative embodiments, additional regions of the film are exposed to a spectrum of presensitizing electromagnetic radiation in a presensitizing scanning pattern. After the delay time, substantially the additional regions of the film are exposed to an additional spectrum of corresponding information-containing electromagnetic radiation in a recording scanning pattern. In some embodiments, the presensitizing scanning pattern and/or recording scanning pattern can be performed in a boustrophedotic fashion, moving to the right, for example, along one row of regions on the film before reversing direction to move to the left for the subsequent row of regions on the film. Refer to the description of FIG. 6 for more information.

In other embodiments, the delay time between exposing additional regions of the film to a spectrum of presensitizing electromagnetic radiation and exposing substantially the additional regions of the film to an additional spectrum of corresponding information-containing electromagnetic radiation is configured by calculating the respective speeds of and the physical separation between the presensitizing scanning head and the recording scanning head.

For example, in some embodiments, a particular delay may be achieved by configuring the presensitizing electromagnetic radiation exposure to scan across the film at a specific speed with a specific physical gap between the leading region exposed to presensitizing electromagnetic radiation and the trailing region exposed to the information-containing electromagnetic radiation.

In alternative embodiments, the aforementioned region and the additional regions may correspond to one or more hogels on the film. In some embodiments, presensitizing the film activates the region of the film causing the film to be more sensitive to exposure of the film to information-containing electromagnetic radiation.

In additional embodiments, the spectrum of presensitizing electromagnetic radiation is configured with a predetermined power and area to deliver a predetermined amount of presensitizing energy density to the region over a predetermined amount of time, and where the spectrum of information-containing electromagnetic radiation is configured with a predetermined power and area to deliver a predetermined amount of recording energy density to the region over a predetermined amount of time.

In some embodiments, for example, the energy densities of the spectrum of presensitizing electromagnetic radiation and of the spectrum of information-containing electromagnetic radiation can be modulated both spatially and temporally in order to maximize the desired presensitization effect and the quality of the resultant recording.

In alternative embodiments, a system for presensitizing a film according to the methods described in [¶21] comprises one or more of the following components:
one or more processors;
one or more memory units coupled to the one or more processors,
one or more presensitizing electromagnetic radiation sources coupled to the one or more processors; and
one or more recording electromagnetic sources coupled to the one or more processors.

In some embodiments, the presensitizing and recording system described in [¶27] may comprise software as well as hardware, such as one or more standard computer processing units (CPUs), digital signal processors (DSPs), and/or application-specific integrated circuits (ASICs).

In alternative embodiments, the presensitizing electromagnetic radiation sources and recording electromagnetic sources in the presensitizing and recording system described in [¶27] correspond to lasers, light-emitting diodes (LEDs), etc.

In additional embodiments, the process of presensitizing and then recording a film can be implemented using a computer program product embodied in a computer-operable medium, the computer program product comprising logic instructions, the logic instructions being effective to implement the methods described in [¶21]. In alternative embodiments, the computer program product is stored on one or more storage devices and/or storage media, such as computer volatile memory, computer hard disk drives, USB flash drives, CDs, DVDs, etc.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

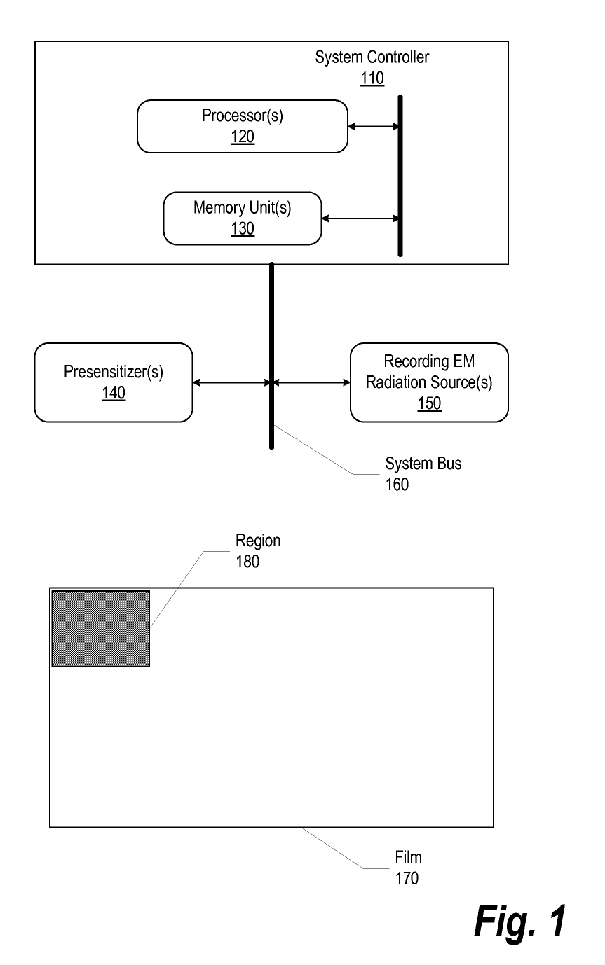

FIG. 1 is a block diagram illustrating a system for presensitizing a film prior to recording information, in accordance with some embodiments.

In some embodiments, the system could comprise a system controller 110 (which itself could comprise one or more processors 120 and one or more memory units 130), one or more presensitizers 110, one or more recording EM radiation sources 150, all of which are directly or indirectly coupled together through a system bus 160.

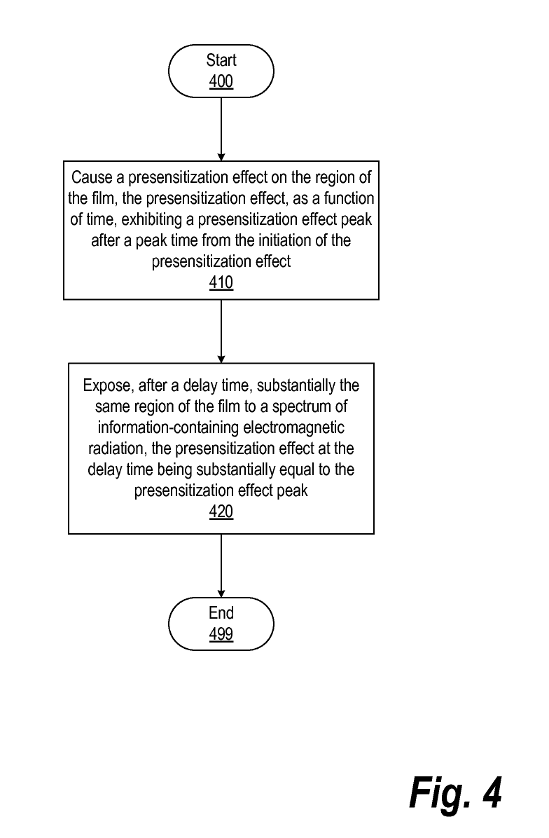

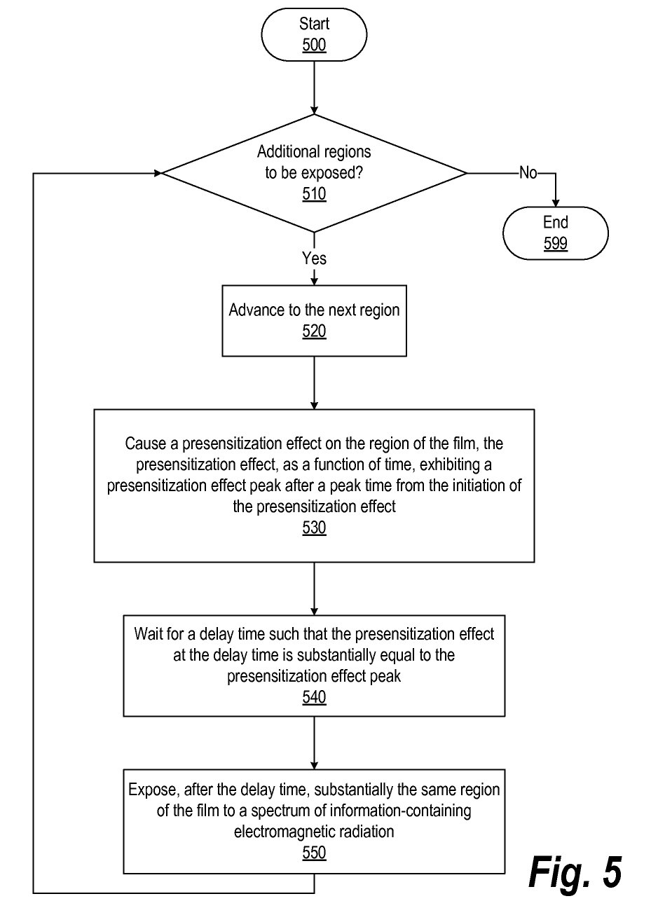

In additional embodiments, the system is operative to presensitize and then record information on one or more regions such as region 180 of a film 170 according to the methods illustrated in FIG. 4, FIG. 5, and FIG. 6.

In some embodiments, presensitizers 140 may be configured to expose region 180 to electromagnetic radiation, heat, moisture, chemicals, etc. in order to achieve presensitization of the region.

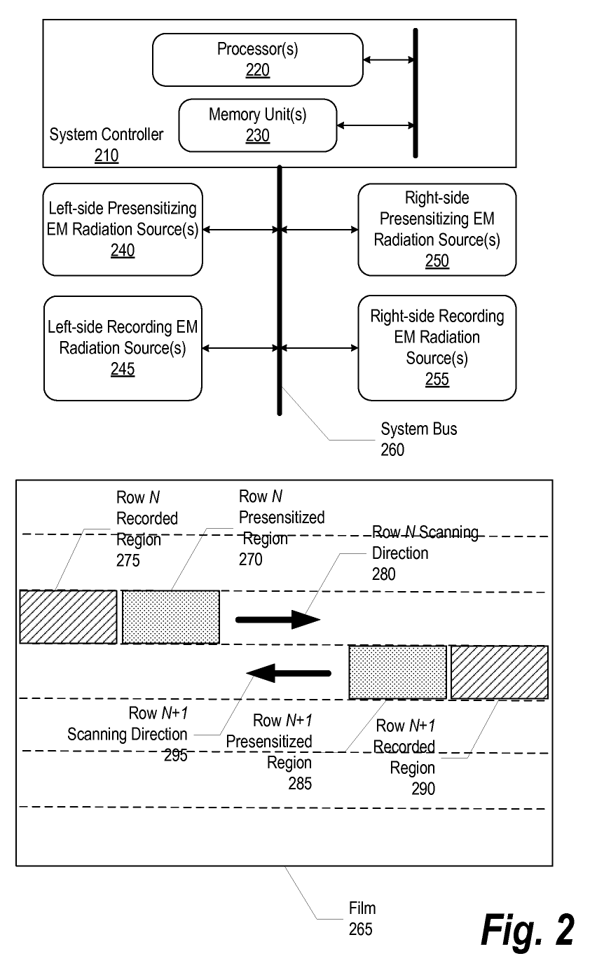

FIG. 2 is a block diagram illustrating a system for presensitizing a film prior to recording information in which the presensitizing and recording scanning patterns are performed in a boustrophedotic fashion, in accordance with some embodiments.

In some embodiments, the system could comprise a system controller 210 (which itself could comprise one or more processors 220 and one or more memory units 230), one or more left-side presensitizing EM radiation sources 240, one or more left-side recording EM radiation sources 245, one or more right-side presensitizing EM radiation sources 250, one or more right-side recording EM radiation sources 255, all of which are directly or indirectly coupled together through a system bus 260.

In additional embodiments, the system operates to presensitize and then record information on one or more regions of a film 265 according to the methods illustrated in FIG. 4, FIG. 5, and FIG. 6, using a boustrophedotic scanning pattern. For example, the left-side presensitizing EM radiation source 240 exposes the row N presensitized region 275 while, after the appropriate delay time, the left-side recording EM radiation source 245 records information in the row N recorded region 275, which was previously presensitized. While region 375 is being recorded, in some embodiments, region 270 may be getting presensitized. In other embodiments, a number of other regions may get presensitized. Subsequent processing moves in the row N scanning direction 280, with presensitizing EM radiation applied ahead of the recording EM radiation.

In some embodiments, when the last region of row N has been processed, processing proceeds to the next row, row N+1, whereupon the scanning direction is reversed, to the new row N+1 scanning direction 290. In a similar fashion, the right-side presensitizing EM radiation source 250 exposes the row N+1 presensitized region 280 while, after the appropriate delay time, the right -side recording EM radiation source 255 records information in the row N+1 recorded region 280, which was previously presensitized. Processing continues for the remaining rows until the entirety (or at least the desired portion) of the film 265 has been presensitized and then recorded.

It should be noted that the boustrophedotic scanning pattern described above is only one possible scanning pattern. Numerous other scanning patterns, modulated both spatially and temporally, could be applied, provided that the presensitization is applied with an appropriate delay time prior to the actual recording.

Additionally, in some embodiments, a single presensitizing EM radiation source could be shared, serving as both the left-side presensitizing EM radiation source 240 and the right-side presensitizing EM radiation source 250. Similarly, in alternative embodiments, a single recording EM radiation source could be shared, serving as both the left-side recording EM radiation source 245 and the right-side recording EM radiation source 255.

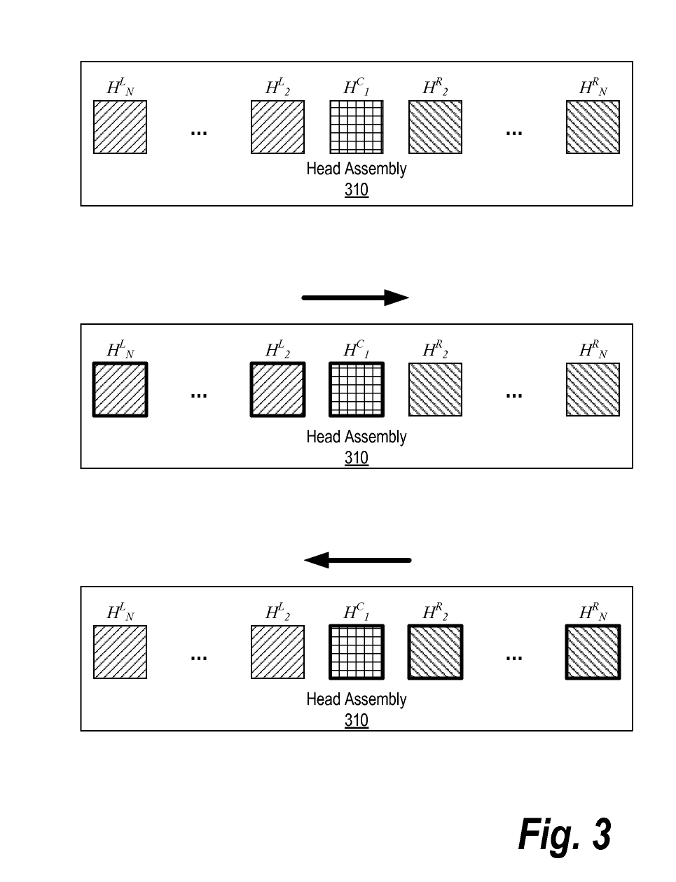

FIG. 3 is a block diagram illustrating a head assembly for applying processes on regions of a film boustrophedoticly, in accordance with some embodiments.

In some embodiments, head assembly 310 comprising 2N+1 heads may be configured to apply N processes to regions of a film boustrophedoticly (bidirectionally). In some embodiments, head assembly 310 comprises N-1 left heads H^{L}₂-H^{L}_{N}, center head if ₁, and right heads H^{R}₂-H^{R} _{N}. Head if , is configured to effect a corresponding process P₁, heads H^{L}₂ and H^{R}₂ are configured to effect a corresponding process P₂, heads H^{L}₃ and H^{R} ₃ are configured to effect a corresponding process P₃, etc.

In some embodiments, when head assembly 310 moves from left to right with respect to the regions on the film, only the left heads and the center head are active. For a particular region on the film, the heads may be activated in the order H_{C}ₜ, H^{L}₂, . . . , H^{L}_{Z}, ..., HL_{N} as the head assembly moves across the region, thereby effecting the corresponding processes P₁, . . . , P_{N} on that region of the film.

In some embodiments, when head assembly 310 moves from right to left with respect to the regions on the film, only the right heads and the center head are active. For a particular region on the film, the heads may be activated in the order H^{C}₁, H^{R}₂, . . . H^{R}_{N} as the head assembly moves across the region, thereby effecting the corresponding processes P₁, . . , P_{N} on that region of the film.

In some embodiments, using this method and head assembly, the same processes may be effected on regions of the film in the same order regardless of the direction in which the head assembly is moving with respect to the film and without the need to rotate the head assembly.

FIG. 4 is a flow diagram illustrating a method for presensitizing a region of a film prior to recording information on the region of the film, such that the presensitization effect is maximized, in accordance with some embodiments.

In some embodiments, the method illustrated in FIG. 4 may be performed by one or more of the systems illustrated in FIG. 1 and FIG. 2. Processing begins at 400 whereupon, at block 410, a presensitization effect is caused on a region of the film, the presensitization effect, as a function of time, exhibiting a presensitization effect peak after a peak time from the initiation of the presensitization effect.

In some embodiments, the presensitization effect on the region of the film is caused at block 410 by exposure to a spectrum of presensitizing electromagnetic radiation. In alternative embodiments, the presensitization effect on the region of the film is caused at block 410 by exposure to one or more presensitizing chemicals. In yet other embodiments, the presensitization effect on the region of the film is caused at block 410 by exposure to a presensitizing pattern of heat, removal of heat or the application of moisture.

At block 420, after a delay time, substantially the same region of the film is exposed to a spectrum of information-containing electromagnetic radiation, the presensitization effect at the delay time being substantially equal to the presensitization effect peak. Processing subsequently ends at 499.

FIG. 5 is a flow diagram illustrating a method for presensitizing additional regions of the film in a presensitizing scanning pattern and then recording on the additional regions of the film in a recording scanning pattern, in accordance with some embodiments.

In some embodiments, the method illustrated in FIG. 5 may be performed by one or more of the systems illustrated in FIG. 1 and FIG. 2. Processing begins at block 500 whereupon, if there are additional regions to be exposed, decision 510 branches to the “Yes” branch where processing moves to block 520, at which point the presensitizing process advances to the next region.

At block 530, a presensitization effect is caused on a region of the film, the presensitization effect, as a function of time, exhibiting a presensitization effect peak after a peak time from the initiation of the presensitization effect.

In some embodiments, the presensitization effect on the region of the film is caused at block 530 by exposure to a spectrum of presensitizing electromagnetic radiation.

In alternative embodiments, the presensitization effect on the region of the film is caused at block 530 by exposure to one or more presensitizing chemicals.

In yet other embodiments, the presensitization effect on the region of the film is caused at block 530 by exposure to a presensitizing pattern of heat.

At block 540, further processing is suspended for a delay time such that the presensitization effect at the delay time is substantially equal to the presensitization effect peak.

At block 550, following the delay time, substantially the same region of the film is exposed to a spectrum of information-containing electromagnetic radiation. Processing then returns to decision 510.

Returning to decision 510, if there are no remaining regions to be exposed, decision 510 branches to the “No” branch, whereupon processing subsequently ends at 599.

FIG. 6 is a flow diagram illustrating a method for presensitizing additional regions of the film in a presensitizing scanning pattern while substantially simultaneously recording on previously presensitized regions of the film in a recording scanning pattern, in accordance with some embodiments.

In some embodiments, the method illustrated in FIG. 6 may be performed by one or more of the systems illustrated in FIG. 1 and FIG. 2. Processing begins at block 600 whereupon at block 610, a presensitization effect is caused on a region of the film, the presensitization effect, as a function of time, exhibiting a presensitization effect peak after a peak time from the initiation of the presensitization effect.

In some embodiments, the presensitization effect on the region of the film is caused at block 610 by exposure to a spectrum of presensitizing electromagnetic radiation.

In alternative embodiments, the presensitization effect on the region of the film is caused at block 610 by exposure to one or more presensitizing chemicals.

In yet other embodiments, the presensitization effect on the region of the film is caused at block 610 by exposure to a presensitizing pattern of heat, removal of heat, application of moisture, etc.

If there are additional regions to be exposed, decision 620 branches to the two parallel “Yes” branches where processing moves substantially simultaneously to block 630a, whereupon the presensitizing process advances to the next region, and to block 630b, whereupon the recording process is suspended for a delay time such that the presensitization effect at the delay time is substantially equal to the presensitization effect peak.

At block 640, following the delay time, substantially the same (now-presensitized) region of the film is exposed to a spectrum of information-containing electromagnetic radiation.

Upon completion of block 630a, processing returns to block 610.

Returning to decision 620, if there are no remaining regions to be exposed, decision 610 branches to the “No” branch, whereupon at block 650, the final, presensitized region of the film is exposed to a spectrum of information-containing electromagnetic radiation. Processing subsequently ends at 699.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for presensitizing film, the method comprising:
causing a presensitization effect on a region of a film, the presensitization effect, as a function of time, exhibiting a presensitization effect peak after a peak time from an initiation of the presensitization effect; and
exposing, after a delay time, substantially the same region of the film to a spectrum of information-containing electromagnetic radiation, the presensitization effect at the delay time being substantially equal to the presensitization effect peak.

2. The method of claim 1, where the causing a presensitization effect on the region of the film comprises at least one of:
exposing the region of the film to a spectrum of presensitizing electromagnetic radiation;
applying moisture to the region of film;
applying heat to the region of film;
removing heat from the region of film;
applying one or more presensitizing chemicals to the region of the film; and
applying a presensitizing pattern of heat to the region of the film.

3. The method of claim 1, further comprising:
causing additional presensitization effects on additional regions of the film; and
exposing sequentially, after the delay time, substantially the additional regions of the film to additional spectrums of corresponding information-containing electromagnetic radiation in a recording scanning pattern.

4. The method of claim 3, where the delay time between the causing additional presensitization effects on additional regions of the film and the exposing substantially the additional regions of the film to additional spectrums of corresponding information-containing electromagnetic radiation is determined by calculating the respective speeds of and the physical separation between the presensitizing scanning pattern and the recording scanning pattern.

5. The method of claim 3, where the region and the additional regions correspond to one or more hogels on the film.

6. The method of claim 2, where the causing a presensitization effect on a region of a film activates the region of the film.

7. The method of claim 2, where the spectrum of presensitizing electromagnetic radiation is configured with a predetermined power and area to deliver a predetermined amount of presensitizing energy density to the region over a predetermined amount of time and where the spectrum of information-containing electromagnetic radiation is configured with a predetermined power and area to deliver a predetermined amount of recording energy density to the region over a predetermined amount of time.

8. A system for presensitizing a film prior to recording information, the system comprising:
one or more processors;
one or more memory units coupled to the one or more processors,
one or more presensitizers coupled to the one or more processors; and
one or more recording electromagnetic sources coupled to the one or more processors,
the system being configured to:
cause the one or more presensitizers to cause a presensitization effect on a region of the film, the presensitization effect, as a function of time, exhibiting a presensitization effect peak after a peak time from an initiation of the presensitization effect; and
cause the one or more recording electromagnetic sources to expose, after a delay time, substantially the same region of the film to a spectrum of information-containing electromagnetic radiation, the presensitization effect at the delay time being substantially equal to the presensitization effect peak..

9. The system of claim 8, where the system being configured to cause a presensitization effect on a region of the film comprises at least one of:
the system being configured to expose the region of the film to a spectrum of presensitizing electromagnetic radiation;
the system being configured to apply moisture to the region of film;
the system being configured to apply heat to the region of film;
the system being configured to remove heat from the region of film;
the system being configured to apply one or more presensitizing chemicals to the region of the film; and
the system being configured to apply a presensitizing pattern of heat to the region of the film.

10. The system of claim 8, the system being further configured to:
cause the one or more presensitizers to cause additional presensitization effects to additional regions of the film in a presensitizing scanning pattern; and
cause the one or more recording electromagnetic sources to expose, sequentially after the delay time, substantially the additional regions of the film to additional spectrums of corresponding information-containing electromagnetic radiation in a recording scanning pattern.

11. The system of claim 10, where the region and the additional regions correspond to one or more hogels on the film.

12. The system of claim 10, where the one or more presensitizing electromagnetic radiation sources are further configured with a predetermined power and area to deliver a predetermined amount of energy presensitizing density to the region over a predetermined amount of time and where the one or more recording electromagnetic radiation sources are further configured with a predetermined power and area to deliver a predetermined amount of recording energy density to the region over a predetermined amount of time.

13. The system of claim 9, where the one or more presensitizers being configured to cause a presensitization effect on the region of the film comprises the one or more presensitizers being configured to activate the region of the film.

14. A computer program product embodied in a computer-operable medium, the computer program product comprising logic instructions, the logic instructions being effective to:
cause a presensitization effect on a region of a film, the presensitization effect, as a function of time, exhibiting a presensitization effect peak after a peak time from an initiation of the presensitization effect; and
cause one or more recording electromagnetic sources to expose, after a delay time, substantially the same region of the film to a spectrum of information-containing electromagnetic radiation, the presensitization effect at the delay time being substantially equal to the presensitization effect peak..

15. The computer program product of claim 14, in which the logic instructions being effective to cause a presensitization effect on a region of the film comprises one or more of the following:
logic instructions being effective to expose the region of the film to a spectrum of presensitizing electromagnetic radiation;
logic instructions being effective to apply moisture to the region of film;
logic instructions being effective to apply heat to the region of film;
logic instructions being effective to remove heat from the region of film;
logic instructions being effective to apply one or more presensitizing chemicals to the region of the film; and
logic instructions being effective to apply a presensitizing pattern of heat to the region of the film.

16. The computer program product of claim 14, the logic instructions being further effective to:
cause additional presensitization effects on additional regions of the film; and
cause one or more recording electromagnetic sources to expose substantially, sequentially after the delay time, the additional regions of the film to additional spectrums of corresponding information-containing electromagnetic radiation in a recording scanning pattern.

17. The computer program product of claim 16, where the region and the additional regions correspond to one or more hogels on the film.

18. The computer program product of claim 16, where the spectrum of presensitizing electromagnetic radiation is configured with a predetermined power and area to deliver a predetermined amount of presensitizing energy density to the region over a predetermined amount of time and where the spectrum of information-containing electromagnetic radiation is configured with a predetermined power and area to deliver a predetermined amount of recording energy density to the region over a predetermined amount of time.

19. The computer program product of claim 15, where the logic instructions being configured to cause a presensitization effect on the region of the film comprises the logic instructions being configured to cause an activation of the region of the film.
